(19) United States
(12) Patent Application Publication
(10) Pub. No.: US 2010/0227552 A1
(43) Pub. Date: Sep. 9, 2010

(54) Underwater radio antenna

(76) Inventors: Mark Volanthen, Hampshire (GB); Mark Rhodes, West Lothian (GB); Brendan Peter Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/752,867

(22) Filed: Apr. 1, 2010

Related U.S. Application Data
(63) Continuation-in-part of application No. 11/454,630, filed on Jun. 15, 2006, now Pat. No. 7,711,322.
(60) Provisional application No. 60/690,964, filed on Jun. 15, 2005.
(60) Provisional application No. 60/690,966, filed on Jun. 15, 2005.
(60) Provisional application No. 60/690,959, filed on Jun. 15, 2005.

(51) Int. Cl. H04B 13/02; H01Q 1/04; H01Q 1/34

(52) U.S. Cl. 455/40; 343/709

(57) ABSTRACT

The present invention provides an antenna for underwater radio communications. The antenna of the present invention comprises an elongate section submerged in water and a feed point for feeding electrical signals to the antenna located on the elongate section, the elongate section is attached to an underwater object at a first end thereof, and during deployment hangs downwards there from so that said elongate section is substantially vertical in orientation. A first portion of the elongate section comprises a flexible wire having an electrically conductive core, which is electrically insulated on an outer surface thereof. During operation the flexible wire radiates electromagnetic signals through the water.

### CROSS-REFERENCE TO RELATED APPLICATION

This application is a continuation in part of U.S. Ser. No. 11/454,630, which claims the benefit of U.S. Ser. Nos. 60/690,964, 60/690,966, and 60/690,959, all filed Jun. 15, 2005. This application is also related to commonly owned, concurrently filed U.S. Ser. No. ______, entitled Buoy Supported Underwater Radio Antenna, Attorney Docket No. WIR 0039. All of the above applications are fully incorporated herein by reference.

### FIELD OF USE

The present invention relates to the field of antennas for wireless communications by electromagnetic signaling in an underwater environment.

### DESCRIPTION OF THE RELATED ART

Wireless communications and data transfer in an underwater environment using radio signaling is preferable over other prior art wireless means for communications, for example by means of acoustic signaling or optical signaling. The benefits of radio signaling over acoustic signaling are the elimination of noise caused by reflections of the signal from hard objects, a significant absence of Doppler effects, and the opportunity to use mature protocols and systems for establishing the radio channel. The benefits of radio signaling over optical signaling are the elimination of local attenuation of the signal arising from turbidity, the elimination of a need for line-of sight. Moreover, systems based on radio communications can operate over multiple co-existing channels without interference.

Prior art antennas for radio communications between submerged objects employ surface antennas. Typically such antennas are maintained in position by a floating apparatus, or are of sufficiently low density so that the antenna will float on the surface of the water. For example, U.S. Pat. No. 3,999,183 “Floatable radio antenna”; Brett, describes an antenna which is located on the surface of the sea and which is kept on the surface by means of a floating apparatus and U.S. Pat. No. 5,406,294 “Floating Antenna System” Silvey et al describes a floating antenna.

Underwater installations or vehicles which are positioned on or near the surface of the water can communicate using radio signals by employing antennas which float on the surface of the water, and which are electrically connected to submerged transceivers. For applications where the installations or vehicles are located well below the surface, such antennas are not practical.

U.S. Pat. No. 4,992,786 “Electrical conductor detector”; Kirkland, describes a system for object location which is based on the transmission of electromagnetic pulses by an underwater cable. However, the system taught by Kirkland provides extremely low efficiency transmission by the underwater cable and is not suitable for conventional radio communications.

Commonly assigned U.S. patent application Ser. No. 11/454,630, “Underwater Communications System and Method”, Rhodes et al., previously incorporated herein by reference, describes a system for communicating underwater by means of low frequency electromagnetic signaling underwater. The system of commonly assigned U.S. patent application Ser. No. 11/454,630 is operable at any depth underwater, not just where the corresponding transceivers are located at or near the surface of the water.

Nonetheless, the high electrical conductivity of seawater creates problems for the transmission of electromagnetic signals in the radio spectrum. A typical value for the conductivity of seawater is 4 S.m⁻¹. This high electrical conductivity produces a correspondingly high rate of attenuation with distance of a radio signal. For a highly conducting medium—such as seawater, an approximate relationship between the attenuation co-efficient of a radio signal α, the angular frequency of the signal ω and the conductivity of the medium through which the signal propagates α is given by Equation 1A.

$$α = \sqrt{\frac{ωμσ}{2}} \qquad Equation 1 A$$

Equation 1B gives the attenuation in dB per meter of a propagating signal and is derived directly from Equation 1A.

Attenuation[dB/m]=(\sqrt{πμσ}20 Log(e))\sqrt{f} Equation 1B

Thus, it can be seen from Equation 1B that the attenuation of a periodic signal increases with the square root of the frequency. Equation 2 gives an expression for the attenuation of a radio signal propagating in seawater having an electrical conductivity of 4 S.m⁻¹.

Attenuation in Seawater[dB/m]=0.03452\sqrt{f} Equation 2

To reduce the rate of attenuation with distance of a radio signal, systems which are based on underwater radio communications use low carrier frequencies. For example, systems based on frequencies in the range from 10 Hz to 10 MHz are proposed in U.S. patent application Ser. No. 11/454,630.

Systems based on low frequency propagation may use magnetically coupled antennas, which provide near-field communications through near-field terms of an electromagnetic or radio signal. Such antennas can be relatively compact compared to antennas which excite the electric field component of a radio signal. However, electrically small magnetically coupled antennas are inefficient at launching a radiating signal which can propagate over a large distance. In order to launch a radiating wave, it is necessary to use an antenna which excites the electric field component of a radio signal.

For the propagation of an electromagnetic wave over distances significantly beyond the near field, antennas having dimensions in the order of one half of one wavelength are required.

Similarly, for the propagation of electromagnetic signals over a long range in a horizontal direction, antennas which are vertically orientated are preferred, as the radiating field pattern from a vertical antenna is uniform in the horizontal directional.

However, such large vertical structures are difficult to deploy in an underwater environment. Moreover, large vertical underwater structures are prone to damage from the high currents and other effects produced by the harsh environment underwater. This is particularly the case in seawater where strong currents and the effects of turbidity can introduce sever mechanical stresses on man-made structures. The cost of erecting a vertical antenna resilient to the harsh environment underwater is another prohibiting factor against their deployment.

### SUMMARY OF THE INVENTION

An object of the present invention is to provide an antenna for underwater communications or data transfer which efficiently radiates low-frequency electromagnetic signals underwater.

A further object of the present invention is to provide an antenna for radiating low-frequency electromagnetic signals which, during deployment, is substantially vertically orientated and which does not require any rigid structure for vertical support.

Another object of the present invention is to provide an antenna for radiating low-frequency electromagnetic signals which can be easily deployed in an underwater environment.

Yet another object of the present invention is to provide a flexible antenna for radiating low-frequency electromagnetic signals which is resilient to the harsh environment underwater, and other subsea conditions that would stress a rigid structure.

Accordingly, the present invention provides an antenna for underwater radio communications. The antenna of the present invention comprises an elongate section submerged in water and a feed point for feeding electrical signals to the antenna located on the elongate section, the elongate section is attached to an underwater object at a first end thereof, and during deployment hangs downwards there from so that said elongate section is substantially vertical in orientation. A first portion of the elongate section comprises a flexible wire having an electrically conductive core, which is electrically insulated on an outer surface thereof. During operation the flexible wire radiates electromagnetic signals through the water.

Embodiments of the present invention will now be described in detail with reference to the accompanying figures in which:

### BRIEF DESCRIPTION OF DRAWINGS

FIG. 1 shows a hydrocarbon production or drilling facility in wireless communications with a remotely operated vehicle (ROV). The hydrocarbon production or drilling facility of FIG. 1 employs an underwater antenna according to the present invention.

FIG. 2A shows a centre-fed underwater antenna for underwater applications according to an embodiment of the present invention.

FIG. 2B shows an enlarged view of the feeding section of the underwater antenna of FIG. 2A.

FIG. 3 shows an end-fed underwater antenna for underwater applications according to another embodiment of the present invention.

FIG. 4 shows an underwater antenna according to an embodiment of the present invention which incorporates a reel mechanism so that the antenna can be deployed and retracted as required.

### DETAILED DESCRIPTION

According to a first aspect, the present invention provides an antenna for underwater radio communications comprising an elongate section submerged in water, a feed point for feeding electrical signals to said antenna being located on said elongate section; said elongate section being attached to an underwater object at a first end thereof and during deployment hanging downwards there from so that said elongate section is substantially vertical in orientation; wherein a first portion of said elongate section comprises a flexible wire having an electrically conductive core, said flexible wire being electrically insulated on an outer surface thereof; and during operation, said flexible wire radiating electromagnetic signals through the water.

In some embodiments a ballast weight having an average density greater than that of the surrounding water is attached to said second end of said elongate section.

In some embodiments, the antenna of the present invention further comprises a signal feed line which feeds electrical signals to or from the antenna and which is coupled to the antenna at said feed point.

The signal feed line may be a coaxial signal line; alternatively, a balanced signal line may be employed. In embodiments employing a coaxial signal line, a balun is optionally disposed between said coaxial signal line and said feed point.

The signal feed line may be connected to said first end of said elongate section of said antenna or at a point between said first end and said second end of said elongate section of the antenna of the present invention.

A feed section is optionally disposed between said signal feed line and said feed point.

In one embodiment, a second portion of said elongate section comprises a flexible wire having electrically conductive core, at least one electrically insulating region, an electrically conductive screen and further comprises an electrically conductive counterpoise; where each of said core, said insulating region, said screen and said counterpoise are coaxially disposed. Preferably, during operation, said second portion said elongate section radiates electromagnetic signals through the water.

In another embodiment, a second portion of said elongate section comprises a pair of spaced apart flexible wires, each of said spaced apart flexible wires having an electrically conductive core and being electrically insulated on an outer surface thereof.

In some embodiments, said first portion of said elongate section has an electrical length which is equal to one half of one wavelength of a centre frequency of operation of the antenna. In other embodiments, said first portion of said elongate section has an electrical length which is equal to one quarter of one wavelength of a centre frequency of operation of the antenna.

In some embodiments, said elongate section has an electrical length which is equal to an integer multiple of one quarter of one wavelength of a centre frequency of operation of the antenna of the present invention.

In some embodiments, during deployment, said elongate section is orientated within an angular range of +/−20 degrees from vertical.

In some embodiments, radio communications takes place by electromagnetic signals having a frequency in the range from 10 Hz to 10 MHz.

In some embodiments, said underwater object is a part of an underwater hydrocarbon extraction or drilling facility. In other embodiments, said underwater object is an underwater remotely operated vehicle. In yet other embodiments, said underwater object is a fixed underwater installation.

In some embodiments, the antenna of the present invention further comprises a reel mechanism for deployment and retraction of the antenna. Deployment and/or retraction of the antenna may be controlled remotely. Furthermore, the reel mechanism may be motorised.

According to a second aspect, the present invention provides a system for underwater wireless communications or wireless data transfer comprising an antenna, said antenna comprising an elongate section submerged in water, a feed point for feeding electrical signals to said antenna being located on said elongate section; said elongate section being attached to an underwater object at a first end thereof and during deployment hanging downwards there from so that said elongate section is substantially vertical in orientation; wherein a first portion of said elongate section comprises a flexible wire having an electrically conductive core, said flexible wire being electrically insulated on an outer surface thereof; and during operation, said flexible wire radiating electromagnetic signals through the water.

The high electrical conductivity of seawater produces a substantial reduction in the wavelength of a radio signal compared to the wavelength of the same signal propagating through air or through a vacuum.

The wavelength of an electromagnetic signal in a conducting medium is given by Equation 3.

$$λ = 2 π \sqrt{\frac{2}{ωμσ}} \qquad Equation 3$$

where ω is the angular frequency of the signal, μ is the magnetic permeability of the medium through which the signal propagates and σ is the electrical conductivity of the medium.

The wavelength of an electromagnetic signal propagating in seawater is given by Equation 4.

$${λ}_{SEAWATER} = 1581 \frac{1}{\sqrt{f}} \qquad Equation 4$$

Efficient communications over a long range by radiating electromagnetic waves requires the use of antennas with dimensions in the order of one half of one wavelength or more. For communications in air, this requirement renders the use of low frequencies—E.G. 100 Hz to 10 kHz—problematic as the antennas required are extremely large. A benefit of communications by electromagnetic signals in seawater is that an antenna with dimensions in the order of one half of one wavelength underwater is realizable even for such low frequency signals. For example: at 10 KHz, the wavelength is only 16 meters in seawater compared to 30 kilometers in air; at 1 KHz, the wavelength is only 50 meters in seawater compared to 300 kilometers in air; at 100 Hz the wavelength is only 160 meters in seawater compared to 3,000 kilometers in air.

By co-incidence, these frequencies are precisely those which are sufficiently low to provide a good range for a radio signal propagating in seawater. For example, radio signals having a carrier frequency of 1 kHz can be received at ranges in the order of hundreds of meters from the source provided the signal is transmitted by a highly efficient antenna and is similarly received by a highly efficient antenna.

Half-wave dipoles are efficient antennas for producing radiating electromagnetic fields. Half-wave dipole antennas can be fed at the centre, where the impedance is low, or can be fed at one end where the impedance is high. Typically, dipole antennas are fed by an unbalanced line, such as a co-axial line. A centre-fed dipole comprises a feed at the centre point, and a device to transform the single-ended feed line to a balanced feed line. Centre feeding is common, as it is easy to match the impedance of the antenna at the centre (where the current is high and the voltage is low) to the low impedance feed line. End-fed dipoles are also common. An end-fed dipole comprises a feed at one end and typically are designed to incorporate matching between the feed line and the very high impedance at the extreme ends of the antenna.

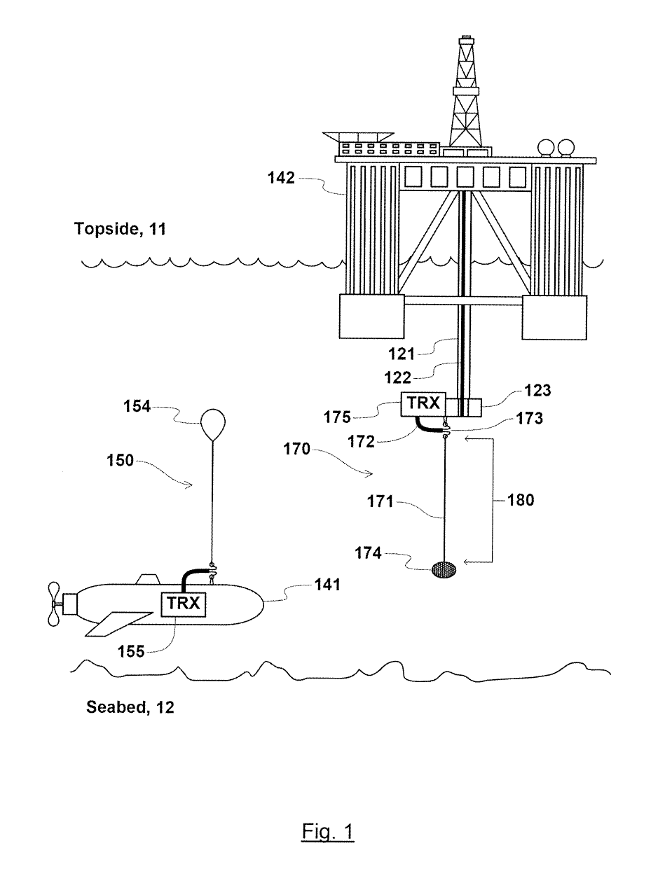

FIG. 1 shows a hydrocarbon production or drilling facility 142 in wireless communications with a remotely operated vehicle (ROV) 141. The hydrocarbon production or drilling facility 142 of FIG. 1 employs an underwater antenna 170 according to the present invention.

Hydrocarbon production or drilling facility 142 further comprises riser 121 and umbilical 122. Umbilical 122 is connected to lower marine riser package 123 at a lower end of riser 121. Signals to be transmitted by transceiver 175 attached to lower marine riser package 123 may be passed from a control station of hydrocarbon production or drilling facility 142 to transceiver 175 via umbilical 122.

The antenna 170 of the present invention depicted in FIG. 1 comprises an elongate section 180 comprising a flexible wire 171 having an electrically conductive core. The flexible wire 171 of elongated section 180 is electrically insulated on the outside so as to isolate the wire from the electrical effects of the surrounding water. For example, the flexible wire 171 may be formed of a thin copper wire core having an insulating plastic jacket. A first end of elongate section 180 is attached to underwater hydrocarbon production or drilling facility 142. Elongate section 180 hangs from its first end in a substantially vertical orientation. A ballast weight 174 is attached to a second end of elongate section 180. Ballast weight 174 has an average density that is greater than that of the surrounding water. Thus, elongate section 180 is maintained in a vertical orientation by ballast weight 174. A signal carrying line 172 connects antenna 170 to transceiver 175 of hydrocarbon production or drilling facility 142. Signal carrying line 172 is connected to flexible wire 171 of elongate section 180 via a feed network 173 which feeds electrical signals from signal carrying line 172 to antenna 170 and vice versa. Feed network 173 may comprise a balun for converting a single-ended signal of signal carrying line 172 to a balanced signal. Alternatively, feed network 173 may comprise passive components to match the impedance of antenna 170 to signal carrying line 172.

The vertically hanging antenna 170 is optimally orientated to launch an electromagnetic signal that radiates substantially uniformly in the horizontal direction. Electromagnetic signals transmitted by underwater antenna 170 may be received by receivers (not shown) comprising similar antennas. Alternatively, electromagnetic signals transmitted by underwater antenna 170 may be received by a transceiver of a nearby remotely operated vehicle 141. ROV 141 may comprise transceiver 155, coupled to a vertically oriented antenna 150 supported by a buoy 154.

During deployment, the orientation of underwater antenna 170 of FIG. 1 may drift slightly from vertical. For example, currents in the water may cause antenna 170 to drift laterally. Nonetheless, provided that antenna 170 of FIG. 1 of the present invention stays within an angle of +/−20 degrees from vertical, the benefits of improved radiation efficiency over an extended range are still available.

Electromagnetic signals transmitted by underwater antenna 170 may similarly be received by receivers of other underwater objects (not shown) comprising electrically small antennas.

A number of designs for an end fed dipole antenna are suitable for use in the present invention. A coaxial fed half-wavelength dipole antenna is one such suitable antenna design. This antenna comprises upper and a lower quarter wavelength sections, where a coaxial feed is passed through lower quarter wavelength section. An alternative design comprises an end-fed half wavelength antenna comprising a quarter wavelength current balun and matching section disposed between the feed line and the antenna. Both types of antenna are most efficient when they are deployed so that all sections are substantially co-linear.

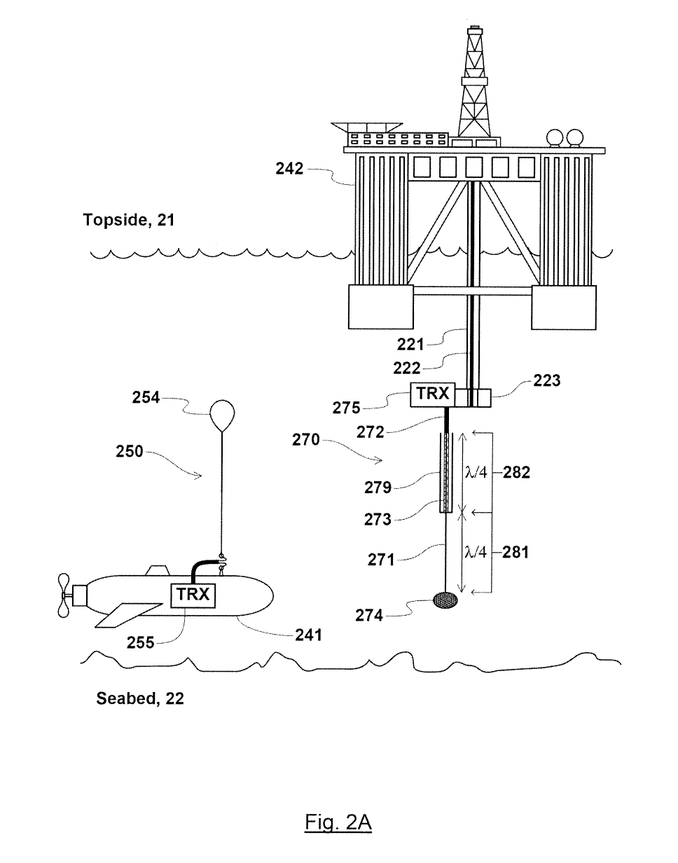

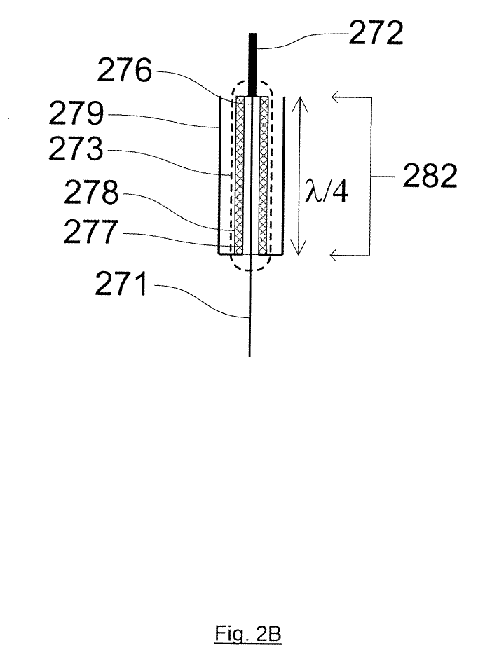

FIG. 2A shows a centre-fed underwater antenna 270 for underwater applications according to an embodiment of the present invention. The antenna of FIG. 2A comprises an elongate section comprising a first portion 281 formed of a flexible wire 271 and further comprising a second portion 282 formed of a plurality flexible co-axial sections. A first end of the elongate section comprising first portion 281 and second portion 282 is attached to an underwater transceiver 275 of hydrocarbon drilling or production facility 242 at a first end thereof. Communications signals may be sent to underwater transceiver 275, for example, from a topside communications station (not shown). Communications signals may be fed along umbilical 222 which runs along the outside of marine riser 221. In the embodiment of the present invention depicted in FIG. 2A, underwater transceiver 275 is attached to lower marine riser package 223 which is connected to umbilical 222 at the lower end of riser 221. First elongate section portion 281 and second elongate section portion 282 are substantially linearly arranged. Similarly, first and second elongate section portions 281, 282 are vertically orientated. A ballast weight 274 is attached to a second end of the elongate section comprising first portion 281 and second portion 282. The average density of ballast weight 274 is greater than that of the surrounding water. Ballast weight 274 maintains antenna 270 in a substantially vertical orientation. Electrical signals are fed to and from a transceiver 275 to antenna 270 via feed line 272. Feed line 272 is typically a co-axial feed line, though a balanced feed line may optionally be employed. Flexible wire 271 has an electrically conductive inner core and an electrically insulated coating (not shown).

The length of flexible wire 271 is approximately one quarter of one wavelength of the centre frequency of the radio signals to be transmitted by the antenna 270.

Second elongate section portion 282 has a length that also is approximately one quarter of one wavelength of the centre frequency of the radio signals to be transmitted by the antenna 270. A feeding section 273 is disposed between feed line 272 and a feed point of the antenna where second elongate section portion 282 joins with first elongate section portion 281. Feeding section 273 electrically connects feed line 272 and antenna 270. Thus, feeding section 273 provides a feeding point of the antenna 270 at the centre thereof.

Second elongate section portion 282 further comprises a cylindrical counterpoise 279 which surrounds feeding section 273. Cylindrical counterpoise 279 is electrically connected to antenna 270 at the position where second elongate section portion 282 meets first elongate section portion 281. The combination of first elongate section portion formed of insulated flexible wire 271 and second elongate section portion 282 containing feeding section 273 and comprising counterpoise 279 together forms a centre fed one half wavelength antenna. Cylindrical counterpoise 279 is coated on the outside with an electrically insulating material (not shown).

In operation, first elongate section portion 281 formed of insulated flexible wire 271 and second elongate section portion 282 comprising counterpoise 279 together radiate electromagnetic signals.

The antenna of the present invention shown in FIG. 2A is particularly suited to underwater communications and/or data transfer by electromagnetic signals having a frequency in the range from 10 Hz to 10 MHz.

Flexible wire 271 of first elongate section portion 281 is ideally formed from materials so that the average density thereof is greater than that of water. The same applies to the constituent parts of second elongate section portion 282. Thus, the antenna of the present invention depicted in FIG. 2A is easily deployed underwater.

In the drawing of FIG. 2A first and second elongated sections 281, 282 are intentionally drawn with enlarged lateral dimensions for illustrative purposes. In physical embodiments, these elements would each be sufficiently thin to maintain flexibility and lightness of the antenna.

FIG. 2B shows an enlarged view of the feeding section 273 of antenna 270 of FIG. 2A. Feeding section 273 comprises a central core 276 of an electrically conductive material, surrounded by a cylindrical region 277 of an electrically insulating material and further surrounded by a cylindrical screen 278 of an electrically conductive material. The combination of central core 276 surrounded by cylindrical region 277 and further surrounded by a cylindrical screen 278 may in some cases be formed of a section of co-axial cable.

In the drawing of FIG. 2B the elements of feeding section 273 are intentionally drawn with enlarged lateral dimensions for illustrative purposes. In physical embodiments, these elements would each be sufficiently thin to maintain flexibility and lightness of the antenna.

The use of materials for first elongate section portion 281 comprising flexible wire 271 and for second elongate section portion 282 ensures that ballast weight 274 is able to provide the required force to keep the antenna of FIG. 2A in a vertical orientation. In particular, an appropriate choice of materials, as would be known to a person skilled in the art, ensures that the mass of ballast weight 274 does not become prohibitively large. For example, the use of highly flexible materials for first elongated section portion 281 and for second elongate section portion 282 minimizes the required mass of ballast weight 274 to maintain antenna 270 in a vertical orientation.

In practical implementations, the length of first elongated section portion 281 and or the length of second elongate section portion 282 may differ from one quarter of one wavelength of the frequency of operation of the antenna. For example, the second elongate section portion 282 may be designed with a shorter length, and may comprise inductive matching to provide an antenna having a second elongate section portion 282 with an effective length of one quarter of one wavelength. Similarly, passive components and design techniques as would be known to a person skilled in the art may be employed to shorten the length of first elongate section portion 281. The use of such techniques, still provides an antenna having first and second elongate section portions 281, 282 having effective electrical lengths of one quarter of one wavelength at the centre frequency of operation of the antenna.

Matching techniques may also be employed at transceiver 275 to match an antenna having an first elongate section portion 281 and/or a second elongate section portion 282 where the physical length is greater than or less than one quarter of one wavelength at the centre frequency of operation of the antenna.

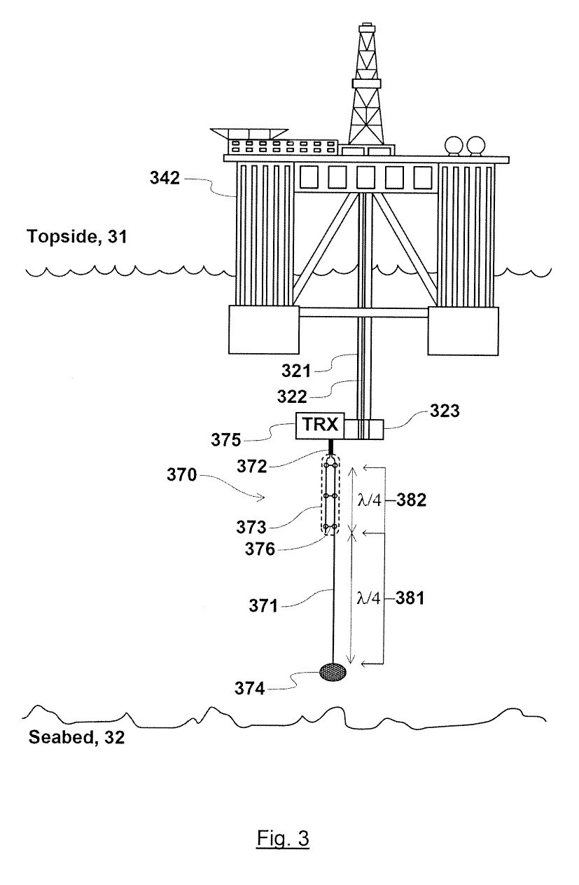

FIG. 3 shows an end-fed underwater antenna 370 for underwater applications according to another embodiment of the present invention. The antenna of FIG. 3 comprises an elongate section 380 and is attached to a transceiver 375 of an underwater hydrocarbon production or drilling facility 342 at a first end thereof. Underwater hydrocarbon production or drilling facility 342 comprises a riser 321 having an umbilical 322 running along an outside surface thereof. A control room (not shown) of underwater hydrocarbon production or drilling facility 342 may send and receive signals to be transmitted by underwater transceiver 375. A first portion of elongate section 380 is formed of a flexible wire 371. A ballast weight 374 is attached to a second end of elongate section 380. The average density of ballast weight 374 is greater than that of the surrounding water. Ballast weight 374 maintains antenna 370 in a substantially vertical orientation. Electrical signals are passed to and from a transceiver 375 to antenna 370 via feed line 372. Feed line 372 is typically a co-axial feed line, though a balanced feed line may optionally be employed. Flexible wire 371 has an electrically conductive inner core and an electrically insulated coating (not shown). The length of flexible wire 371 is approximately one half of one wavelength of the centre frequency of the radio signals to be transmitted by antenna 370.

A feed section 373 is disposed at the bottom of flexible wire 371. Feed section 373 is approximately one quarter of one wavelength long and comprises a pair of flexible wires separated by spacers 376. Spacers 376 are employed to maintain a fixed characteristic impedance of feed section 373. The feed section 373 provides single ended to balanced conversion to eliminate return currents that might otherwise be induced on feed line 372. Feed section 73 is also electrically insulated on the outside.

In operation, first portion of elongate section 380 which is formed of a flexible wire 371 radiates electromagnetic signals.

The antenna of the present invention shown in FIG. 3 is particularly suited to underwater communications and/or data transfer by electromagnetic signals having a frequency in the range from 10 Hz to 10 MHz.

Flexible wire 371 is ideally formed from materials so that the average density is greater than that of water. For example, the electrically conductive core may be of copper, and the insulated coating may be a polymer having a density greater than 1000 kg M⁻³ so that the combined average density of the core plus insulation is greater than that of water. The same applies to the pair of flexible wires and spacers 376 which form feed section 373. Thus, the antenna of the present invention depicted in FIG. 3 is easily deployed underwater.

In some cases, the antenna 370 of FIG. 3 is more efficient than the antenna of FIG. 2A due to its increased length, and the greater spacing of the antenna 370 from underwater hydrocarbon production or drilling facility 342 compared to the spacing of antenna 270 from underwater hydrocarbon production or drilling facility 242.

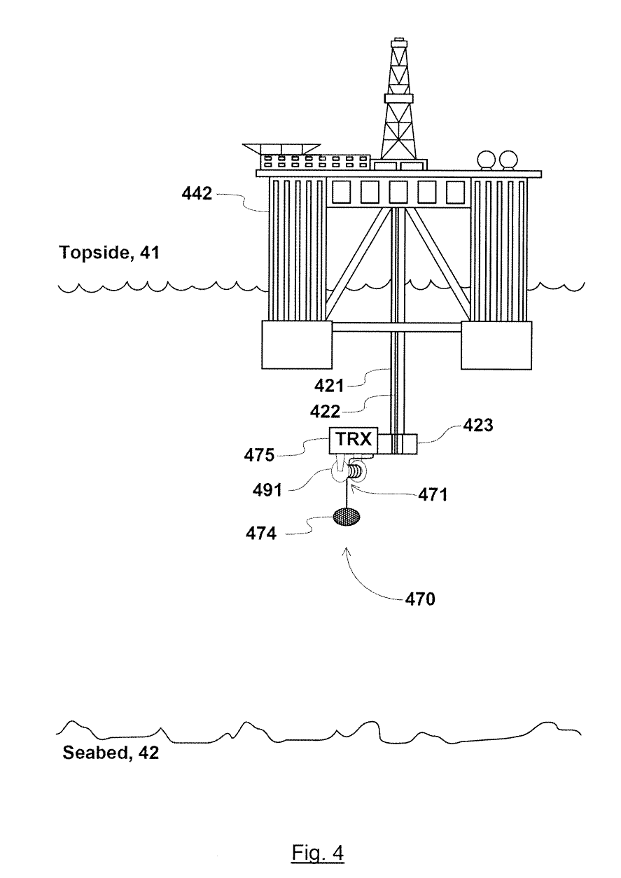

FIG. 4 shows an underwater antenna 470 according to an embodiment of the present invention which incorporates a reel mechanism 491 so that the antenna can be deployed and retracted during use as required.

Antenna 470 of FIG. 4 is attached to a transceiver 475 of an underwater hydrocarbon production or drilling facility 442. Underwater hydrocarbon production or drilling facility 442 comprises a riser 421 having an umbilical 422 running along an outside surface thereof. A control room (not shown) of underwater hydrocarbon production or drilling facility 442 may send and receive signals to be transmitted underwater by transceiver 475. Antenna 450 comprises an elongated section formed of a flexible wire 471 which is wrapped around reel mechanism 491. A ballast weight 474 is attached at an end of flexible wire 471. Flexible wire 471 has an electrically conductive inner core and an electrically insulated coating (not shown). When extended, the length of flexible wire 471 is approximately one half of one wavelength of the centre frequency of the radio signals to be transmitted by the antenna 470 of FIG. 4.

Antenna 470 of FIG. 4 is deployed by unwinding reel mechanism 491. The unwinding of reel mechanism 491 may be powered, for example, by an electrical motor (not shown). Similarly, the unwinding of reel mechanism 491 may be triggered by a remotely control signal. For example, a control signal may be sent by transceiver 475 or by a control centre of underwater vehicle 441. After deployment, and during use, electrical signals are fed to and from a transceiver 475 to the antenna 470 via feed line 472. Antenna 470 may subsequently be retracted when the transmission of data or signals is no longer required.

The reel mechanism 491 of antenna 470 may be mounted on an outside surface of an element underwater hydrocarbon production or drilling facility 442 as shown in FIG. 4. Alternatively, the reel mechanism 491 may be mounted inside an element underwater hydrocarbon production or drilling facility 442. For example, reel mechanism 491 may be mounted inside lower marine riser package 423.

The antennas embodying the present invention depicted in FIG. 2A, FIG. 2B, FIG. 3 and FIG. 4 herein are suitable for use to transmit and receive radio signals to or from any underwater installation. For example, the antennas of FIG. 2A, FIG. 2B, FIG. 3 and FIG. 4 may be deployed for use in fixed underwater installations, such as in sections of hydrocarbon production facilities or in sections of hydrocarbon drilling facilities. Similarly, the antennas of FIG. 2A, FIG. 2B, FIG. 3 and FIG. 4 may be deployed for use in underwater vehicles, such as remotely operated vehicles (ROV) or autonomous underwater vehicles (AUV).

Thus, the present invention embodied in the various figures and descriptions described herein provide an antenna for underwater communications which is substantially vertically orientated. The antenna of the present invention does not require a rigid supporting structure and efficiently radiates low-frequency electromagnetic signals underwater. Moreover, the present further provides an antenna for radiating low-frequency electromagnetic signals which can be easily deployed in an underwater environment. The antenna of the present invention is flexible and is resilient to the harsh environment underwater, and other subsea conditions that would stress a rigid structure.

The antenna for underwater radio communications of the present invention may be used for the transmission of voice telephony, the transmission of static or video images, or the transfer of control commands. In general, the antenna for underwater radio communications of the present invention is suitable for the transmission of any form of data, that can be sent by radio communications. The term radio communications used herein does not impose any limitation on the scope of the present invention to data transfer between two or more people in the colloquial sense.

Embodiments of the underwater radio antenna of the present invention are described herein with particular emphasis on seawater environments having a specific salinity and a corresponding specific electrical conductivity. However, any optimization of the present invention to suit particular water constitutions remains within the scope of the present invention.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. An antenna for underwater radio communications comprising an elongate section submerged in water, a feed point for feeding electrical signals to said antenna being located on said elongate section;
said elongate section being attached to an underwater object at a first end thereof and during deployment hanging downwards there from so that said elongate section is substantially vertical in orientation;
wherein a first portion of said elongate section comprises a flexible wire having an electrically conductive core, said flexible wire being electrically insulated on an outer surface thereof; and during operation, said flexible wire radiating electromagnetic signals through the water.

2. An antenna for underwater radio communications according to claim 1 wherein a ballast weight having an average density greater than that of the surrounding water is attached to said second end of said elongate section.

3. An antenna for underwater radio communications according to claim 1 further comprising a signal feed line which feeds electrical signals to or from said antenna via said feed point.

4. An antenna for underwater radio communications according to claim 3 wherein said signal feed line is a coaxial signal line.

5. An antenna for underwater radio communications according to claim 4 further comprising a balun disposed between said coaxial signal line and said feed point.

6. An antenna for underwater radio communications according to claim 3 wherein said signal feed line is a balanced signal line.

7. An antenna for underwater radio communications according to claim 3 wherein said signal feed line is connected to said first end of said elongate section of said antenna.

8. An antenna for underwater radio communications according to claim 3 wherein said signal feed line is connected at a point between said first end and a second end of said elongate section of said antenna.

9. An antenna for underwater radio communications according to claim 3 further comprising a feed section disposed between said signal feed line and said feed point.

10. An antenna for underwater radio communications according to claim 1, said elongate section further comprising a second portion having an electrically conductive core, at least one electrically insulating region, an electrically conductive screen and an electrically conductive counterpoise, each of said core, said insulating region, said screen and said counterpoise being coaxially disposed.

11. An antenna for underwater radio communications according to claim 10 wherein during operation said second portion of said elongate section radiates electromagnetic signals through the water.

12. An antenna for underwater radio communications according to claim 1, said elongate section further comprising a second portion comprising a pair of spaced apart flexible wires, each of said spaced apart flexible wires having an electrically conductive core and being electrically insulated on an outer surface thereof.

13. An antenna for underwater radio communications according to claim 1 said first portion of said elongate section having an electrical length which is equal to one half of one wavelength of a centre frequency of operation of said antenna.

14. An antenna for underwater radio communications according to claim 1 said first portion of said elongate section having an electrical length which is equal to one quarter of one wavelength of a centre frequency of operation of said antenna.

15. An antenna for underwater radio communications according to claim 1 said elongate section having an electrical length which is an integer multiple of one quarter of one wavelength of a centre frequency of operation of said antenna.

16. An antenna for underwater radio communications according to claim 1 wherein, during deployment, said elongate section is orientated within an angular range of +/−20 degrees from vertical.

17. An antenna for underwater radio communications according to claim 1 wherein radio communications takes place by means of electromagnetic signals having a frequency in the range from 10 Hz to 10 MHz.

18. An antenna for underwater radio communications according to claim 1 wherein said underwater object is a part of an underwater hydrocarbon drilling or production facility.

19. An antenna for underwater radio communications according to claim 1 wherein said underwater object is an underwater remotely operated vehicle.

20. An antenna for underwater radio communications according to claim 1 wherein said underwater object is an underwater installation fixed to the seabed.

21. An antenna for underwater radio communications according to claim 1 wherein said elongate section has a density that is greater than the surrounding water.

22. An antenna for underwater radio communications according to claim 1 further comprising a reel mechanism for deployment and retraction of the antenna.

23. An antenna for underwater radio communications according to claim 22 wherein deployment and retraction of the antenna is controlled remotely.

24. An antenna for underwater radio communications according to claim 22 wherein said reel mechanism is a motorized mechanism.

25. A system for wireless communications or wireless data transfer underwater comprising the antenna of claim 1.
